(19) United States
(12) Patent Application Publication
(10) Pub. No.: US 2005/0070635 A1
(43) Pub. Date: Mar. 31, 2005

(54) Wood composites bonded with protein-modified urea-formaldehyde resin adhesive

(75) Inventors: Robert A. Breyer, Tucker, GA (US); Jason Rivers, Atlanta, GA (US); Kelly Shoemake, Conyers, GA (US); John Everett Thompson, Atlanta, GA (US); Winford T. Liles, Conyers, GA (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA (US)

(21) Appl. No.: 10/671,885

(22) Filed: Sep. 29, 2003

(51) Int. Cl. C08L 1/00

(52) U.S. Cl. 524/13

(57) ABSTRACT

An adhesive binder composition containing a urea-formaldehyde resin modified with a protein, preferably with a source of soy protein and the use of the binder for preparing wood composites, especially particleboard.

### BACKGROUND OF THE INVENTION

1. Field of the Invention

This invention relates to wood composites prepared using a modified, thermosetting urea-formaldehyde resin composition as a component of an adhesive binder. In particular, the invention relates to wood composites prepared using an adhesive binder composition comprising a thermosetting urea-formaldehyde resin (UF) modified by the addition of a binding-enhancing amount of a protein, especially a soy protein. The invention also relates to a process for preparing wood composites using an adhesive binder containing a protein-modified urea-formaldehyde resin.

2. Description of Related Art

Urea-formaldehyde (UF) resins have long been used in the preparation of wood composites, particularly wood composites for interior use, such as particleboard, medium density fiberboard and other composites made from small pieces of wood. UF resins have been a binder of choice because of their processing advantages and low cost relative to other typical wood adhesives. UF resin-based adhesives have good bonding properties and other characteristics that permit them to be used in high-speed processes for the preparation of the various boards or wood composite products. As employed in the manufacture of composite board products, short press cycles can be achieved with urea-formaldehyde resin-based adhesives. Also, urea-formaldehyde adhesives have a desirable level of “tack”, causing adhesive-treated particles to stick to each other, so that mats made from a “tacky” furnish tend to be self-sustaining in shape, which facilitates handling during board manufacture.

Urea-formaldehyde resins are typically prepared by reacting urea and formaldehyde at a suitable mole ratio to form various methylolated ureas and their higher condensation products. The composition of any particular resin depends, inter alia, on temperature, pH and time for the reaction.

Wood composites made with an adhesive binder containing a urea-formaldehyde resin have generally been limited to applications where exterior durability is not required. Unfortunately, one of the drawbacks of using urea-formaldehyde resins as a component of wood composite adhesive binders is that such resins tend to release formaldehyde into the environment. This can be a particular problem in the case of UF adhesives because of their use primarily in interior applications. While the amount of the formaldehyde being liberated may be small, sufficient amounts may be emitted to provide a detectable formaldehyde odor, which is objectionable. Formaldehyde is malodorous and is thought to contribute to human and animal illness.

Manufacturers using UF resin-based adhesive binders continue to seek for ways to produce lower formaldehyde-emitting wood composite products. One approach has been to use resins with lower F/U molar ratios in the adhesive binders. Unfortunately, lower mole ratio resins tend to result in reduced board properties, such as decreased internal bond strengths, due to a lower extent of cure under equivalent pressing conditions. Such resins also tend to be slower curing than the higher mole ratio, more reactive resins. Because of this, additives that might improve board properties (especially at short press times), while maintaining equivalent, or even lower formaldehyde emissions, would have a large economic benefit for manufacturers.

Therefore, a wood composite binder that provides the advantages of conventional urea-formaldehyde resins with reduced formaldehyde emissions, and at a reduced cost would be advantageous.

U.S. Pat. Nos. 6,306,997 and 6,518,387 describe an adhesive binder made from a soybean flour and a crosslinking agent and is taught as a replacement for urea-formaldehyde resins.

U.S. Pat. No. 6,497,760 describes a modified soy protein adhesive, prepared by reaction of soy protein with such modifiers as urea, sodium dodecylbenzene sulfonate (SDBS), sodium dodecyl sulfate (SDS) and guanidine HCl.

U.S. Pat. No. 6,231,985 describes using a mixture of an isocyanate-terminated prepolymer and hydrolyzed soy protein as a wood adhesive.

WO 01/59026 describes methylolating soy protein (e.g., with formaldehyde) and then reacting it with co-monomers including methylolated urea for use as a wood composite adhesive. The methylolation of the soy and the comonomer can take place simultaneously in the same reactor. In the examples, the soy protein source constituted a major portion of the resin solids.

U.S. Pat. No. 4,282,119 describes the preparation of chipboard purportedly showing a strongly reduced formaldehyde-emission using a urea-formaldehyde or urea-melamine-formaldehyde resin as an adhesive binder, wherein said binder contains 0.45 to 0.65 mole of formaldehyde per mole-equivalent of amino groups and to which between 2 and 20% by wt., relative to the resin, of a protein soluble or dispersible in the resin solution has been added. The resin preferably contains between 25 and 45% by wt. of melamine, relative to the combined amount of urea and melamine. The boards are reported to have good strength and weather resistance, and a low formaldehyde emission.

Lorenz, L. F. et al., Forest Products Journal, 49 (3):73-78 (1999) describes modifying urea-formaldehyde (UF) resins with soy protein, hydrolysed soy protein, soy flour, or casein, at 1.5 to 50% of UF solids, to determine if modifying the resins would reduce formaldehyde emissions. Differential scanning calorimetry was used to determine the reactivity of the modified UF resins compared with unmodified UF resin. According to the results, the reactivity was reduced as the added protein modifier increased, but up to 30% protein modifier could be added to the UF resin before the reactivity was reduced significantly. As reported, formaldehyde emissions from cured UF resins were not decreased as the amount of protein modifier added to the resin was increased.

Despite these disclosures, there is a continuing need for identifying new adhesive binder compositions suitable for making wood composites.

Generally, it is advantageous to impart faster cure to UF resin based adhesive binders. The time required during the pressing stage often is the production-limiting step in many wood composite manufacturing plants. Therefore, any adhesive that can produce a wood composite product of improved performance properties at shorter press times, is desired. Shortening the press time by only a few seconds can result in considerable increases in profits to board manufacturers.

### BRIEF DESCRIPTION OF THE INVENTION

The invention is broadly directed to an aqueous adhesive binder composition for making wood composites. The adhesive binder is principally based on a thermosetting urea-formaldehyde (UF) resin.

The invention is more specifically directed to an aqueous adhesive binder composition containing as its major component a thermosetting, UF resin and as a minor, modifying component a protein, preferably a vegetable protein and especially a soy protein. The invention also is directed to a process for preparing wood composites, particularly particleboard and medium density fiberboard, using the adhesive binder, and to wood composites produced by the method.

This invention is based on the discovery that by adding an effective, binding-enhancing amount of a protein, preferably a vegetable protein and especially a soy protein such as soy flour, to a thermosetting urea-formaldehyde (UF) resin-based binder and using the modified composition as a component of a wood composite adhesive binder, wood composites having enhanced internal bond strengths and enhanced tack at a low residual formaldehyde emission can be produced.

Interest has again been on the increase for finding ways to reduce the usage of petroleum-based raw materials. Sources of soy protein, in particular, are being reconsidered as an alternative ingredient in adhesive compositions to reduce the reliance on petroleum-based polymers and to reduce environmental pollution.

### DETAILED DESCRIPTION OF THE INVENTION

The thermosetting urea-formaldehyde (UF) resin used as the major component of the binder composition of the present invention can be prepared from urea and formaldehyde monomers or from UF precondensates in manners well known to those skilled in the art and the present invention is not limited to any specific resins. Suitable resins are commercially available. Skilled practitioners recognize that the urea and formaldehyde reactants are commercially available in many forms. Any form which can react with the other reactants and which does not introduce extraneous moieties deleterious to the desired reaction and reaction product can be used in the preparation of urea-formaldehyde resins useful in the invention.

As well-understood by those skilled in the art, formaldehyde for making a suitable UF resin is available in many forms. Paraform (solid, polymerized formaldehyde) and formalin solutions (aqueous solutions of formaldehyde, sometimes with a small amount of methanol, in 37 percent, 44 percent, or 50 percent formaldehyde concentrations) are commonly used forms. Formaldehyde also is available as a gas. Any of these forms is suitable for use in preparing a UF resin in the practice of the invention. Typically, formalin solutions are preferred as the formaldehyde source for ease of handling and use.

Similarly, urea is available in many forms. Solid urea, such as prill, and urea solutions, typically aqueous solutions, are commonly available. Further, urea may be combined with another moiety, most typically formaldehyde and urea-formaldehyde adducts, often in aqueous solution. Any form of urea or urea in combination with formaldehyde is suitable for use in the practice of the invention. Both urea prill and combined urea-formaldehyde products are preferred, such as Urea-Formaldehyde Concentrate or UFC 85. These types of products are disclosed in, for example, U.S. Pat. Nos. 5,362,842 and 5,389,716 and are well known to skilled workers.

Any of the wide variety of procedures used for reacting the principal urea and formaldehyde components to form an aqueous UF thermosetting resin composition also can be used, such as staged monomer addition, staged catalyst addition, pH control, amine modification and the like. The present invention is not to be limited to a restricted class of UF resins or any specific synthesis procedure. Generally, the urea and formaldehyde are reacted at a mole ratio of formaldehyde to urea in the range of about 1.1:1 to 4:1, and more often at an F:U mole ratio of between about 1.5:1 to 3.2:1.

There are two reactions involved in reacting urea and formaldehyde resins: an “addition” reaction and a “condensation” reaction. The condensation reaction leads to polymer growth, high molecular weight and eventually cure. As well understood by those skilled in the art, the condensation reactions are allowed to continue during resin synthesis until a thermosetting resin with desired rheological characteristics for the intended use are obtained. Following synthesis of the UF resin, the resin is neutralized and more urea and other additives are added to obtain the final resin composition. It is common to back-add additional urea to the resin composition as a way of reducing the level of free formaldehyde. Any form of urea can be used, including UF concentrates. As a consequence of such post-synthesis modifications the F:U mole ratio of the final resin composition is typically in the range of about 0.6:1 to about 1.6:1, depending on the final product requirements as known to those skilled in the art, and most often between about 0.6:1 to about 1.4:1.

Many thermosetting urea-formaldehyde resins which may be used in the practice of this invention are commercially available. Urea-formaldehyde resins such as the types sold by Georgia Pacific Resins, Inc., including 544D49, 544D97 and 670D17, for wood bonding applications, and those sold by Borden Chemical Co., and by Dynea may be used. These resins are prepared in accordance with the previous teachings and contain reactive methylol groups, which upon curing form methylene or ether linkages. Such methylol-containing adducts may include N,N′-dimethylol, dihydroxymethylolethylene; N,N′bis(methoxymethyl), N,N′-dimethylolpropylene; 5,5-dimethyl-N,N′dimethylolethylene; N,N′-dimethylolethylene; and the like.

Urea-formaldehyde resins useful in the practice of the invention generally contain 45 to 75%, and preferably, 55 to 65% non-volatiles, generally have a viscosity of 50 to 1400 cps, preferably 150 to 600 cps, normally exhibit a pH of 7.0 to 9.0, preferably 7.5 to 8.5, and often have a free formaldehyde level of not more than about 3.0%, often less that 1%, and a water dilutability of from less than 1:1 to 100:1, preferably 1:1 and above.

The reactants for making the UF resin may also include a small amount of resin modifiers such as ammonia, alkanolamines, or polyamines, such as an alkyl primary diamine, e.g., ethylenediamine (EDA). Additional modifiers, such as melamine, ethylene ureas, and primary, secondary and tertiary amines, for example, dicyanodiamide, can also be incorporated into UF resins used in the invention. Concentrations of these modifiers in the reaction mixture often will vary from 0.05 to 20.0% by weight of the UF resin solids. These types of modifiers promote hydrolysis resistance, polymer flexibility and lower formaldehyde emissions in the cured resin. As noted above, further urea additions for purposes of scavenging formaldehyde or as a diluent also may be used.

The second component of the UF resin-based adhesive binder composition of this invention is a protein. The invention is based on the discovery that adding an effective, binding-enhancing amount of a protein, preferably a vegetable protein and especially a soy protein, to any thermosetting UF resin tailored for making a wood composite adhesive binder that the wood composites made with that adhesive have improved internal bond strengths. Sources of such proteins are well known to those skilled in the art. The protein may be an animal protein such as soluble blood (e.g., blood albumen) or casein, or it may be a vegetable protein such as soybean (soy) or zein flour (corn).

Vegetable protein is preferred and a particularly preferred protein source is soy protein. The vegetable protein material can be in the form of ground whole beans (including the hulls, oil, protein, minerals, etc.), a meal (extracted or partially extracted), a flour (i.e., generally containing less than about 1.5% oil and about 30-35% carbohydrate), or an isolate (i.e., a substantially pure protein flour containing less than about 0.5% oil and less than about 5% carbohydrate). As used herein in the specification and claims, “flour” includes within its scope material that fits both the definitions of flour and isolate.

Preferably, the vegetable protein is in the form of a protein flour, at least because the adhesive binder and related wood composite products produced from the binder made with a flour, as opposed to a meal, are expected to have more desirable physical properties.

Any source of soy protein (such as soybean concentrate or soybean meal) is suitable for use as the binder modifier in the present invention. Protein-rich soybean-derived flours, such as soy protein isolate, protein concentrate and ordinary defatted soy flour, which contain in the range of about 20-95% protein should each be suitable. Of these, ordinary soy flour is the most abundant and cost-effective. The source of soy protein (soy flour) is preferably essentially free of functional urease.

Other proteinaceous materials useful as the modifier in this invention, in addition to the aforementioned animal and milk byproducts and soy and corn vegetable protein include, to the extent they contain protein, flours made from other varieties of other leguminous beans and seeds, such as sunflower and rape-seeds.

Information on soy protein can be found in, for example, Kirk-Othmer, Encyclopedia of Chemical Technology, Fourth Edition, Volume 22, pp. 591-619 (1997).

Preferably, the vegetable protein has a particle size (as determined by the largest dimension) of less than about 0.1 inch (0.25 cm), and more preferably less than about 0.05 inch (0.125 cm). If the particle size is much larger than this, the protein material may not be sufficiently soluble or dispersible to produce an adhesive binder suitable for making wood composites with optimum properties. In those embodiments where the protein is blended with the resin before application to the wood particles, the time required to solubilize the material tends to be undesirably longer with larger particles.

A protein flour is more preferred because of its generally smaller particle size distribution. That is, the most preferred ground vegetable protein has a maximum particle size of that of a flour, i.e., about 0.005 inch (0.013 cm). There does not appear to be a minimum particle size requirement for the ground vegetable protein; however, the particle size of commercially available soybean flour is generally less than about 0.003 inch (0.008 cm). For example, in some commercially available soybean flour, greater than about 92% passes through a 325 mesh screen, which corresponds to a particle size of less than about 0.003 inch (0.008 cm). Thus, a wide range of soy flours are expected to be suitable, such as a flour having at least 90 to 95% of its particles smaller than 100 mesh, smaller than 200 mesh, or smaller than 400 mesh.

To prepare the adhesive binder, its is possible in the broad practice of the present invention to simply add the protein to a previously prepared aqueous thermosetting UF resin in a desired proportion and under ambient conditions. Alternatively, it also is possible to include the protein in the reaction mixture at some point during the time period in which the UF resin is prepared, for example during the addition, or the condensation portion of the UF synthesis. In another embodiment, the protein can be applied to the wood pieces separate from the UF resin, for example by spraying a solution or dispersion of the protein onto the wood pieces prior to, or after application of the UF-resin based adhesive binder to the wood, all before heating the composite mat to consolidate/cure the adhesive binder. Thus, in the broad practice of the present invention, any way of combining the protein with the UF resin before curing the adhesive binder of the wood composite can be used.

It is preferred, however, to add the protein at a point during the preparation of the UF resin or the resin-based adhesive binder that maximizes the amount of free formaldehyde available for reaction with the protein. As a consequence, in preferred practice the protein will be added during the synthesis of the UF resin when the addition reaction or the initial condensation reactions are occurring. It is believed that by adding the protein at such a point in the synthesis of the UF resin will maximize the potential improvement in internal bond obtained as a consequence of using the protein and will best enhance the “tackiness” of the resin as well.

The aqueous, protein-modified UF resin typically has a Brookfield viscosity in the range of 50 to 1400 cps at a solids content of 45 to 70%.

In order to insure suitable storage stability of the adhesive binder composition and proper performance during use of the adhesive binder composition, it is desirable that the pH of the aqueous binder be adjusted, as needed, to a pH within the range of about 6 to 9, and more preferably between about 7 and 8.5. Too low a pH may cause premature curing of the UF resin and incompatibility of the two constituents; while too high a pH may retard curing of the composition on heating when it is used.

Suitable binders can be prepared by including an amount of protein to provide, on a solids basis, a weight ratio of UF solids to protein solids (UF:Protein) between about 99.9:0.1 and about 90:10, usually, between about 99.9:0.1 and 90.5:9.5, preferably between about 99.8:0.2 and about 93:7 and most often in the range of 99.5:0.5 and about 95:5.

The total concentration of non-volatile components in the adhesive binder composition (predominantly UF resin and protein solids) also can vary widely in accordance with the practice of the present invention, but it will usually be found convenient and satisfactory to make up this composition at a total solids concentration in the range from about 25 to about 75 percent by weight of the total aqueous adhesive binder composition, more usually in the range of 35 to 70 percent by weight. Total solids from about 40 to about 65 percent by weight are preferred. As used herein, the solids content of a composition is measured by the weight loss upon heating a small, e.g., 1-5 gram sample of the composition at about 105° C. for about 3 hours.

The adhesive binder composition may also contain a variety of other known additives such as fire retardants, for example silica to enhance fire resistance, wax to enhance water resistance, antifoamers, lubricants, plasticizers, softening agents, pigments, biocides, fillers, and the like, normally in small proportions relative to the required UF resin and protein constituents.

The amount of adhesive binder applied to the wood pieces also can vary considerably in the broad practice of the present invention, but loadings in the range of about 1 to about 45 percent by weight, preferably about 4 to about 30 percent by weight, and more usually about 5 to about 20 percent by weight, of nonvolatile binder composition based on the dry weight of the wood pieces, will be found advantageous in preparing most wood composite products. In the case of making plywood, the level of adhesive usage in generally expressed as glue spreads. Glue spreads in the range of 50 lbs to 110 lbs of adhesive per 1000 square feet of glue line, when the veneer is spread on both sides, or in the range of 25 lbs to 55 lbs, when the glue is spread on only one side of the veneer are normally used for making plywood.

Wood composites such as oriented stand board, particleboard, flake board medium density fiberboard, waferboard, and the like are generally produced by applying the adhesive binder to the wood pieces, such as by blending or spraying the processed lignocellulose materials (wood pieces) such as wood flakes, wood fibers, wood particles, wood wafers, wood strips, wood strands, or other comminuted lignocellulose materials with an adhesive binder composition while the materials are tumbled or agitated in a blender or equivalent apparatus. When making plywood (such as hardwood plywood for interior applications), the adhesive can be applied to the veneers by roll coater, curtain coater, spray booth, foam extruder and the like.

After applying and/or blending the adhesive and lignocellulose materials sufficiently to form a substantially uniform mixture, the wood pieces are formed into a loose mat, which then is generally compressed between heated platens or plates to set (cure) the binder and bond the flakes, strands, strips, pieces, and the like, together in densified form. Conventional pressing processes are generally carried out at temperatures of from about 120 to 225° C. in the presence of varying amounts of steam generated by liberation of entrained moisture from the wood or lignocellulose materials. Some processes use a combination of press curing with hot platens and heat generated by radio frequency. This combination may permit rapid curing with a reduced press time. Interior grade plywood is prepared by assembling the wood veneers into panels and consolidating the panels also under heat and pressure. This is usually done in a steam hot-press using platen temperatures of 115° to 180° C. and pressures of 75 to 250 psi.

In these processes, the moisture content of the lignocellulose material is usually between about 2 and about 20% by weight, before it is blended with the aqueous adhesive binder. One exception is medium density fiberboard, where the adhesive resin typically is applied to the green (un-dried) wood fiber and then passed through a dryer.

For example, when manufacturing particleboard, the aqueous UF resin-based adhesive is sprayed onto the wood particles generally in an amount of from about 4 to about 20 parts of resin solids per 100 parts of dry wood (4 to 20% by weight). The resin-treated wood particles are then formed into a mat, and compacted in a hot press to the desired density. Particleboard panels are usually made to have a density in the range from about 35 to about 60 lbs/ft³. Typically, the thickness of particleboard falls in the range from about one-eighth inch to two inches.

In addition to the mat-forming hot pressing process, wood composite products from small wood pieces also have been made using an extrusion process. In this process, a mixture of the wood particles, resin adhesive, and other additives is forced through a die to make a flat board. The present invention is not limited to any particular way of making the wood composites.

By adding an acid catalyst to a UF resin, the rate of cure of the adhesive binder also can be adjusted to essentially any desired speed. UF resin based adhesive binders may even be cured at ambient temperatures by catalysis with free acid. Oftentimes, a combination of a moderate increase in acidity and an elevated temperature is employed to cure the adhesive. When making particleboard, it is common to rely upon the inherent acidity of the wood furnish to provide a reduced pH for cure, the pH normally varying from about pH 4-6.5, depending on the wood species. Alternately, a latent catalyst, or a free acid, may be added if faster cure speeds are required. Latent catalysts commonly employed include amine-acid salts, such as NH₄Cl and (NH₄)₂SO₄, which react with free formaldehyde generated during cure, and subsequently release free acid. Other non-buffering inorganic salts also can be used to enhance cure speed.

The adhesive binder composition of the invention sets or cures at elevated temperatures below the decomposition temperature of the UF resin and protein components. The setting or curing of the adhesive binder composition normally can occur at temperatures from about 100° C. to about 300° C., preferably from about 100° C. to about 275° C. At these temperatures, the adhesive binder composition will typically cure in periods ranging from a few seconds to several minutes or more. Although the adhesive binder may cure more rapidly at higher temperatures, excessively high temperatures can cause deterioration of the binder composition, which in turn may cause a deterioration of the physical and functional properties of the wood composite. Of course, lower temperatures and/or longer times can also be employed if desired.

The present invention is not limited to any particular process for uniting the adhesive binder with the wood material, or for consolidating the adhesive binder-treated wood into a coherent, cured product.

As used herein, “curing,” “cured” and similar terms are intended to embrace the structural and/or morphological change which occurs in the adhesive binder of the present invention as it is heated to cause covalent chemical reaction, ionic interaction or clustering, improved adhesion to the substrate, phase transformation or inversion, and hydrogen bonding.

A surprising benefit of the protein addition in addition to the improved internal bond strength was the enhanced tack of the protein-modified resin. The protein-modified resin not only had more tack than an unmodified control, but tended to retain the tack for a longer period of time than the control resin made without the added protein (soy flour).

The following example is intended to be illustrative only and does not limit the scope of the claimed invention.

### EXAMPLE 1

A comparative study was done using a commercial resin GP544D49. This resin was made both as the standard, unmodified resin and with 1% soy flour reacted into the resin by adding it during resin synthesis. Both resins were used in the manufacture of particleboard. The boards were made with a density of 49 lb/ft³ and used 8% resin solids to dry wood solids. The mats were pressed at 165° C. for four minutes. The control board had an internal bond strength (IB) of 225 psi, while the protein (soy flour) modified board had an IB of 275 psi. This represents a 22% improvement in IB.

Wood composites made with the soy modified UF resin-based adhesive binder thus exhibited enhance internal bonds (IBs) relative to products made with an adhesive containing the unmodified UF resin.

While the invention has been described with reference to certain preferred embodiments, and exemplified with respect thereto, those skilled in the art will appreciate that various changes, substitutions, modifications and omissions may be made without departing from the spirit of the invention. Accordingly, it is intended that the scope of the present invention be limited solely by that of the following claims. Unless otherwise specifically indicated, all percentages are by weight. Throughout the specification and in the claims the term “about” is intended to encompass + or −5%.

1. A wood composite bonded with an adhesive binder composition comprising a urea-formaldehyde resin modified with a protein, wherein the protein was added during synthesis of the urea-formaldehyde resin to modify the resin, said protein provided in an amount of 0.1% to 10% by weight of resin solids.

2. The wood composite of claim 1 wherein the protein is a vegetable protein.

3. The wood composite of claim 2 wherein the vegetable protein is a soy protein.

4. The wood composite of claim 3 wherein the soy protein is a soy flour.

5. The wood composite of claim 4 made using a wood source selected from wood flakes, wood fibers, wood particles, wood wafers, wood strips, wood strands, and wood veneer.

6. The wood composite of claim 5 wherein the adhesive binder composition has a formaldehyde to urea mole ratio in the range of about 0.6:1 to about 1.6:1.

7. (Cancelled)

8. The wood composite of claim 6 wherein said protein is provided in an amount of 0.2% to 7% by weight of resin solids.

9. The wood composite of claim 8 wherein the urea-formaldehyde resin is synthesized at an initial formaldehyde to urea mole ratio in the range of 1.5:1 to 3.2:1.

10. A process for making a wood composite comprising applying an adhesive binder composition to a source of wood material, the adhesive binder composition comprising a urea-formaldehyde resin modified with a protein, wherein the protein was added during synthesis of the urea-formaldehyde resin to modify the resin said protein provided in an amount of 0.1% to 10% by weight of resin solids, consolidating said wood material and curing said modified urea-formaldehyde resin.

11. The process of claim 10 wherein the protein is a vegetable protein.

12. The process of claim 1 1 wherein the vegetable protein is a soy protein.

13. The process of claim 12 wherein the soy protein is a soy flour.

14. The process of claim 13 wherein the wood source is selected from wood flakes, wood fibers, wood particles, wood wafers, wood strips, wood strands, and wood veneer.

15. The process of claim 14 wherein the adhesive binder composition has a formaldehyde to urea mole ratio in the range of about 0.6:1 to about 1.6:1.

16. (Cancelled)

17. The process of claim 15 wherein said protein is provided in an amount of 0.2% to 7% by weight of resin solids.

18. The process of claim 17 wherein the urea-formaldehyde resin is synthesized at an initial formaldehyde to urea mole ratio in the range of 1.5:1 to 3.2:1.
